(19) United States
(12) Patent Application Publication
(10) Pub. No.: US 2024/0367191 A1
(43) Pub. Date: Nov. 7, 2024

(54) ROBOTIC FLUID SPRAYING CONTROL SYSTEM WITH SPRAY TIP WEAR COMPENSATION

(71) Applicant: Wagner Spray Tech Corporation, Plymouth, MN (US)

(72) Inventors: Joseph W. KIEFFER, Chanhassen, MN (US); Jeshwanth Durga Sagar KUNDEM, Minneapolis, MN (US)

(21) Appl. No.: 18/652,939

(22) Filed: May 2, 2024

Related U.S. Application Data
(60) Provisional application No. 63/499,741, filed on May 3, 2023.

(51) Int. Cl. B05B 12/16; B05B 12/00

(52) U.S. Cl. CPC B05B 12/16; B05B 12/004; B05B 12/006

(57) ABSTRACT

A robotic paint spraying system includes a paint applicator including a spray tip having at least one tip orifice, a propulsion system comprising one or more actuators configured to move the paint applicator relative to a surface, and a control system. The control system is configured to obtain one or more spraying parameters representing a target paint spraying operation, generate a first actuator control signal that controls the propulsion system to move the spray tip at a speed relative to the surface, control the robotic paint spraying system to spray paint from the spray tip at a target pressure, obtain an indication of tip wear of the spray tip, generate a movement parameter based on the indication of tip wear, and generate a second actuator control signal that controls the propulsion system to move the spray tip based on the movement parameter.

### CROSS-REFERENCE TO RELATED APPLICATION

The present application is based on and claims the benefit of U.S. provisional patent application Ser. No. 63/499,741, filed May 3, 2023, the contents of which are hereby incorporated by reference in their entirety.

### BACKGROUND

A fluid spraying system can be used to spray a fluid from a fluid source to an application area. For example, paint can be sprayed by an applicator, such as a spray gun or head having a spray tip, to a wall or other target surface. Some spraying systems employ robotic components that support the applicator on a control module that controls the flow of paint through the spray tip (e.g., to start, stop, and/or control paint thickness, etc.). Further, the robotic components are carried on a movable frame having actuators that control the positioning of the spray tip relative to the surface.

The discussion above is merely provided for general background information and is not intended to be used as an aid in determining the scope of the claimed subject matter. The claimed subject matter is not limited to implementations that solve any or all disadvantages noted in the background.

### SUMMARY

A robotic paint spraying system includes a paint applicator including a spray tip having at least one tip orifice configured to spray a paint, a propulsion system comprising one or more actuators configured to move the paint applicator relative to a surface to be sprayed, and a control system. The control system is configured to obtain one or more spraying parameters representing a target paint spraying operation corresponding to the surface, generate a first actuator control signal that controls the propulsion system to move the spray tip at a speed relative to the surface, control the robotic paint spraying system to spray paint from the spray tip to the surface at a target pressure, obtain an indication of tip wear of the spray tip, generate a movement parameter based on the indication of tip wear, and generate a second actuator control signal that controls the propulsion system to move the spray tip relative to the surface based on the movement parameter.

These and various other features and advantages will be apparent from a reading of the following Detailed Description. This Summary and Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic block diagram of a robotic spraying system, in one example.

FIG. 2-1 is a diagrammatic view of one example of a robotic spraying system.

FIG. 2-2 is a diagrammatic view of one example of a robotic spraying system.

FIG. 3 is a diagrammatic view of one example of a robotic spraying system.

FIGS. 4-1 and 4-2 (collectively referred to as FIG. 4) illustrate operation of a robotic spraying system, in one example.

FIG. 5 is a perspective view showing a robotic spray head, in one example.

FIG. 6 is a side view showing a spray tip, in one example.

FIG. 7 is a flow diagram 700 showing an example operation of a spraying system.

FIG. 8 provides a chart illustrating example spray tip orifice size calculations based on relationships between pressure and flow rate.

FIG. 9 shows one example of the system illustrated in FIG. 1, deployed in a remote server environment.

FIGS. 10-12 show examples of mobile devices that can be used in the architectures shown in the previous Figures.

FIG. 13 is a block diagram showing one example of a computing environment that can be used in the architectures shown in the previous Figures.

While the above-identified figures set forth one or more examples of the disclosed subject matter, other examples are also contemplated, as noted in the disclosure. In all cases, this disclosure presents the disclosed subject matter by way of representation and not limitation. It should be understood that numerous other modifications and examples can be devised by those skilled in the art which fall within the scope and spirit of the principles of this disclosure.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

Further, while some examples are described herein in the context of applying paint to a surface, it is understood that the concepts are not limited to these particular applications. Other applications include applying other types of fluids, such as, but not limited to, foams, textured materials, adhesive components, food products, water, disinfectants, to name a few.

As used herein, “paint” includes substances composed of coloring matter, or pigments, suspended in a liquid medium as well as substances that are free of coloring matter or pigment. Paint can include preparatory coatings, such as primers, and can be opaque, transparent, or semi-transparent. Some particular examples include, but are not limited to, latex paint, oil-based paint, stain, lacquers, varnishes, inks, etc.

Further yet, some examples are discussed herein in the context of “airless” spraying systems which typically spray fluid by pressurizing the fluid through a positive displacement pump (e.g., a piston pump driven by an electric motor), or other type of pumping system, to a pressure that results in atomization of the fluid from a spray tip having a geometry configured to emit a particular spray pattern (e.g., a round pattern, a flat pattern, a fan pattern, etc.). However, it is expressly contemplated that the present features can also be utilized with other types of sprayers, such as air driven or air pressurized sprayers, that utilize an air compressor, air turbine, or other air source that generates air flow to spray the fluid.

Robotic spraying systems can be utilized in spraying operations to at least partially automate, or otherwise increase the overall efficiency of, a spraying operation. For example, a robotic sprayer can be controlled to undergo a spraying operation on a target surface. While robotic sprayers are advantageous in their ability to automate a spraying operation, robotic systems are often limited in their capability.

For instance, during operation, as the fluid is pumped at pressure through the spray tip, the spray tip wears, or otherwise ages, and the characteristics of the tip (e.g., the spray pattern shape/size, flowrate, internal turbulation, etc.) can change. For example, a new tip may dispense twenty ounces per minute (oz/min), while that same tip, after some usage, may dispense twenty-two oz/min due to an increase in orifice size. Further, the change in orifice size can also affect the dimensions of the spray pattern. These changes in the spray pattern and/or dispersion rate affect the coverage and/or thickness of the fluid on the surface which can result in uneven coverage, areas of under or over spray.

It can be difficult to control the movement of the spray tip relative to the surface to account for changes in the tip wear. These problems can be especially different to overcome in robotic spraying systems.

The present disclosure generally relates to a control system for a robotic spraying system that is configured to compensation for tip wear. The control system can detect changes in the flow rate and/or spray pattern, which can be caused by tip wear over time, and to perform compensation to achieve a desired target. For consistent or otherwise improved spray coverage, examples of the present system accounts for wear affects by adjusting control of the robotic spraying system. For instance, a speed of the spray tip and/or a pressure of the pump can be adjusted to achieve a desired thickness of the fluid on the surface. In some examples, the diameter of the tip orifice can be calculated based on one or more of the sensed pressure, pump speed (e.g., RPMs), pump displacement, etc. Additionally, a “life” of the tip can be determined by comparing a current tip's orifice size to the tip's initial orifice size (e.g., 100% tip life) and an unacceptably worn tip orifice size (e.g., 0% tip life).

While at least some examples are discussed herein in the context of a robotic spraying system, the present features can be applicable to other types of spraying systems, such as user carried or controlled sprayers. For instance, some airless systems include a handheld portable spray gun, sometimes referred to as a “cup gun”. The portable unit includes a reciprocating piston pump driven by a motor and powered by an on-board battery, and a paint source (e.g., a paint cup), carried on the sprayer. In another example, a handheld spray gun is coupled to a paint pump by a length of hose. The paint pump can be positioned on a cart or other portable frame that the user can transport about a worksite.

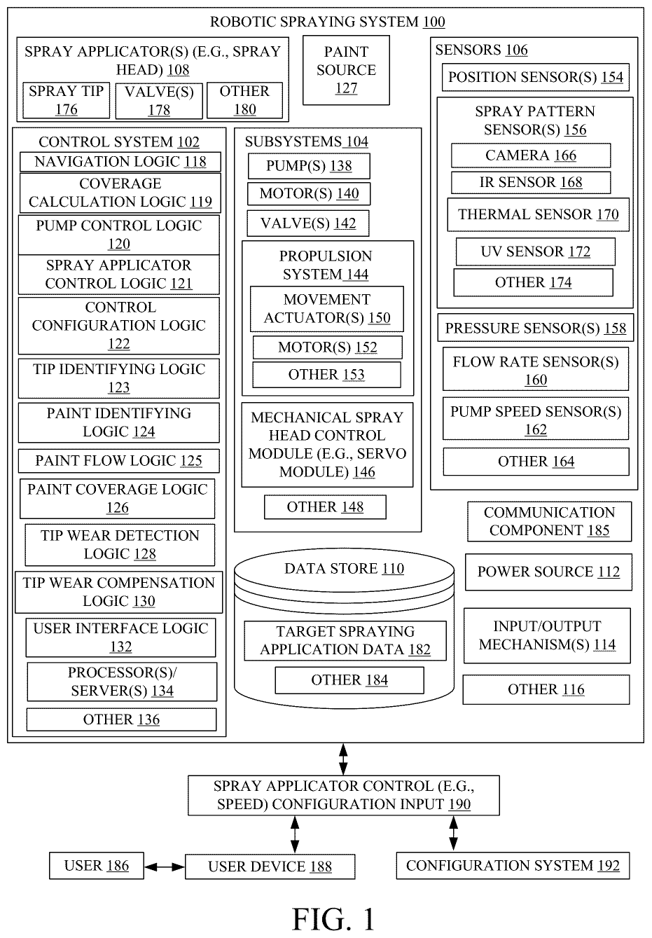

FIG. 1 is a schematic block diagram of one example of a robotic spraying system 100. System 100 is illustratively an autonomous or semi-autonomous system machine for performing a spraying application with some, or all, spraying tasks being performed with a degree of autonomy. For example, system 100 can generate or plan a path for the spray tip to achieve a target coverage (e.g., area and thickness), and the spray tip can be automatically moved (e.g., distance and speed relative to the surface) through control of actuators and spray control valve(s) are opened/closed through automation to achieve a target spray coverage area and/or thickness.

Example autonomous machines can perform ground-based operations, such as traversing the ground or floor to spray a vertical surface. Other examples include aerial vehicles, such as an unmanned aerial vehicle (UAV) or drone.

System 100 includes a control system 102 configured to control one or more subsystems 104 and receive sensor signals from one or more sensors 106. System 100 includes one or more spray applicators 108, a data store 110, a power source 112 (such as one or more batteries), input/output mechanism(s) 114, and can include other items 116 as well. For sake of illustration, but not by limitation, spray applicators 108 will be discussed in the context of a spray head (also referred to herein as spray head 108).

Control system 102 includes navigation logic 118, coverage calculation logic 119, pump control logic 120, spray applicator control logic 121, control configuration logic 122, tip identifying logic 123, paint identifying logic 124, paint flow logic 125, paint coverage logic 126, a paint source 127, tip wear detection logic 128, tip wear compensation logic 130, user interface logic 132, one or more processors and/or server(s) 134, and can include other items 136 as well.

Subsystem(s) 104 includes one or more pumps 138, one or more motors 140, one or more valves 142, a propulsion system 144, mechanical spray head control module 146, and can include other items 148 as well.

Propulsion system 144 is configured to move system 100 about a worksite and includes one or more movement actuators 150, one or more motors 152, and can include other items 153 as well.

Sensors 106 include one or more position sensors 154, one or more spray pattern sensors 156, one or more pressure sensors 158, one or more flow rate sensors 160, one or more pump speed sensors 162, and can include other sensors 164 as well.

Spray pattern sensor(s) 156 can include a camera 166, an infrared (IR) sensor 168, a thermal sensor 20, an ultraviolet (UV) sensor 22, and can include other sensors 24 as well. For example, the sensor signals from sensor(s) 156 can provide information relating to paint application, spray edges (e.g., locations of spray edges), spray density (e.g., thickness), spray angles, etc.

Spray applicator 108 includes a spray tip 176, one or more valves 28, and can include other items 180 as well. Data store 110 can include any of a variety of data items for controlling spraying system 100 or logging operation of spraying system 100. For example, data store 110 can store target spraying application data 182 and can include other data items 184 as well.

Position sensor signal(s) are configured to generate sensor data indicating an absolute and/or relative position of robotic spraying system 100. For example, position sensor signal(s) can detect a relative position of the robotic spraying system 100, relative to the surface to be painted, and generate a sensor signal indicative of the relative position. For instance, the position sensor signal can indicate a current distance of the spray tip from the surface to be sprayed, changes in the distance of the spray tip from the surface to be sprayed, a distance of the spray tip from the ground, to name a few. Alternatively, or in addition, the position sensor signal(s) can determine changes in the relative position of the spray tip, such as a degree of lateral movement of the spray tip along the surface to be sprayed. For instance, based on the position sensor signal(s), control system 102 can determine how many feet per second the spray tip along the surface as spray applicator 108 is making during a spray pass.

Examples of position sensor(s) 154 include, but are not limited to, radar sensors, global positioning system (GPS) sensors, accelerometers, and/or gyroscopes, to name a few.

Control system 102 is configured to control operation of system 100 based on sensor signals from sensors 106 and other inputs, such as target spraying application data 182 which defines the target coverage (the target surface location and area, the target coating thickness, etc.). Control system 102 is configured to monitor and control the speed of pump(s) 138 to achieve a desired paint pressure and controls the location and movement speed of spray tip 176 to achieve a desired target coating thickness within the target area on the surface.

Control system 102, in one example, includes a computing device, such as a microprocessor that communicatively couples to other elements of system 100. In one example, control system 102 includes integrated software or logic components to perform a variety of different functions. Control system 102 can include computer processors with associated memory and timing circuitry, not separately shown. They are functional parts of the systems or devices to which they belong and are activated by, and facilitate the functionality of the other components or items in those systems.

Data 182 can be received by spraying system 100 in any of a number of ways. For example, it can be transmitted from a remote computing system, such as a server or a mobile device, or can be input directly into system 100, such as by a user interacting with user input devices (not shown in FIG. 1).

Navigation logic 118 receives position sensor signals from position sensors 154 and controls a path of spray tip 176 to achieve the desired spraying application. For example, the control can include planning a series of parallel passes along the surface and a desired speed of spray tip 176 to achieve a desired paint coating coverage and thickness.

Coverage calculation logic 119 is configured to calculate the spray coverage (e.g., thickness, area, etc.) based on operating characteristics, such as flow rate, spray pattern, pressure, etc. In one example, discussed in further detail below, logic 119 calculates the mil thickness of the paint on the surface based on an indication of the flow rate of the paint through the orifice and an indication of the area of the surface being covered with the current pass, which can be based on sensor signals from sensors 154 and/or 156. A mil is a measurement that equals one-thousandth of an inch, or 0.001 inch. One mil also equals 0.0254 mm (millimeter). The speed and/or distance of the spray tip relative to the surface can be adjusted to achieve a target mil thickness.

Pump control logic 120 is configured to control pump 138, such as by controlling the speed of motor 140 driving pump 138, to achieve a desired pressure and/or flow rate of the paint to spray tip 176.

Tip wear detection logic 128 is configured to detect a tip wear status of spray tip 176. Some examples are discussed above. Briefly, however, tip wear detection logic 128 can determine a current spray tip orifice size based on current operational characteristics, such as pressure and flow rate, and compare the current tip size to a first tip size, which can be the initial or manufactured tip size. The change in tip size can be correlated to a tip wear or remaining tip life.

Tip wear compensation logic 130 is configured to control one or more of subsystem(s) 104 to compensate for the tip wear detected by logic 128. Examples are discussed in further detail below. Briefly, however, as spray tip 176 wears, the tip orifice becomes larger, which can result in changes in the spray pattern and amount of paint being released from the spray tip orifice. To illustrate, without changes to the distance of the spray tip to the surface or speed at which the spray tip is moved relative to the surface, the spray pattern may become narrowed (less area being covered by the spray pattern) and the thickness of the paint coating can increase. Examples of compensating for tip wear include, but are not limited to, automatically increasing the distance of spray tip 176 from the surface, increasing the lateral speed at which spray tip 176 moves relative to the surface, to name a few.

Spray pattern sensor(s) 156 are configured to generate sensor signals indicative of the spray pattern released from spray tip 176. For example, camera 166 can acquire images of the spray pattern as it travels from spray tip 176 to the surface. Alternatively, or in addition, sensors 168, 170, and/or 172 can generate sensor signals indicating the area of the surface being covered by the current pass of the spray tip 176 along the surface. Examples of spray pattern sensors are discussed in U.S. patent application Ser. No. 18/172,439, which is hereby incorporated by reference in its entirety. Briefly, in some examples, spray pattern sensor(s) 156 can include one or more of an infrared (IR) sensor, a thermal imager, and an ultraviolet (UV) sensor. As the paint is sprayed during a given pass relative to a target surface, particles of the paint dissipate in response to environmental conditions as the paint travels through the atmosphere at a particular spray angle to the target surface to be coated. As this atomization occurs, the surface area of the spray increases and evaporation occurs, which results in the spray temperature dropping to a lower level than its surroundings, such as a lower level than the temperature of the surface to which the paint has been applied. The decrease in temperature of the spray can be detected by spray pattern sensor(s) 156. In this way, spray pattern sensor(s) 156 can generate sensor data representing spray characteristics, such as a determination of the spray edges (e.g., locations of spray edges). Additionally, the identified characteristics may include spray angle, spray density (e.g., spray thickness), spray coverage, etc.

The characteristics can be utilized by control system 102 to control the positioning of spray application 108. For example, a control signal can include an indication to change location, which causes propulsion system 144 to rotate wheels or tracks or cause actuator(s) 150 to drive movement of a robotic arm, or both. In one example, control system 102 controls subsequent passes of spray applicator 108 based on detected spray edges. In one instance, a subsequent pass can be controlled to overlap the spray edges of a previous pass with an additional spray to ensure adequate paint coverage on the surface. For example, it may be desired to overlap 50% (or half) of a previous pass with a subsequent pass. In this way, each portion of the surface gets double coated. Other desired overlap parameters (e.g., other percentage overlaps) can be utilized as well.

Pressure sensors 158 return an indication of the pressure of the paint released from spray tip 176. This can include receiving an indication of the commanded pressure being used to control pump 138. Alternatively, or in addition, one or more pressure transducers can be positioned along the paint flow path to spray tip 176.

Flow rate sensors 160 generates a flow rate sensor signal indicative of the flow rate of the paint through spray tip 176. In one example, a flow rate sensor can be disposed along the flow path to measure the flow rate, such as in gallons per minute (GPM). Alternatively, or in addition, an indication of flow rate can be determined based on pump speed (based on signals from pump speed sensor 162). For example, in the case of a piston pump, the cycles or strokes per minute and pump displacement per stroke can be utilized to determine the flow rate of the paint being output from the pump.

Valve(s) 178 are configured to control the flow of paint to spray tip 176. For example, a needle valve can be configured to actuate between open and close positioned to control the flow of paint from spray tip 176. Valve 178 can be controlled by navigation logic 118 to achieve the target spraying application. Additionally, navigation logic 118 can control operation of spraying system 100 based on environmental characteristics, such as temperature, wind speed, humidity, etc.

Propulsion system 144 is configured to move spraying system 100 relative to the surface to be sprayed, and is controlled by navigation logic 118. For example, one or more movement actuators 150 is driven by motor 152 to move spray tip 176 in six degrees of freedom. For example, in the case of a ground robot, movement actuators 150 can include wheels or tracks configured to convey system 100 over the ground. Actuators 150 can also include actuators that move the spray tip relative to the ground engaging elements (such as by raising and lowering the spray tip relative to the wheels or tracks). In the case of an aerial robot, movement actuator 150 can include rotors that move system 100 through the air. Further, spray tip 176 can be mounted to system 100 using a controllable gimbal assembly.

Mechanical spray head control module 146 is configured to receive and control spray head (or other actuator(s)) 108.

Spray applicator control logic 121 is configured to control module 146 to control when spray applicator 108 sprays paint from spray tip 176. For example, control logic 121 can control the opening and/or closing speed of valve(s) 178.

Control configuration logic 122 operates to configure control logic 121, for example to control the speed at which logic 121 controls module 146 to open and/or close valve(s) 178 of spray applicator 108.

Tip identifying logic 123 receives sensor signals that indicate the tip model and serial number. In one instance, tip identifying logic 123 receives sensor signals from a camera and identifies tip 176 based on the image (e.g., by reading a machine-readable code in the image, using optical character recognition to read a serial/model number, etc.). In another instance, tip identifying logic 123 receives sensor signals from a wireless communications sensor and identifies tip 176 based on the wireless signal (e.g., a RFID signal, a Bluetooth signal, an NFC signal, etc.). In another instance, tip identifying logic 123 generates interactive components on an interface that enables a user to manually select tip 176. In other examples, tip identifying logic 123 can identify tip 176 in other ways as well.

Paint identifying logic 124 identifies the paint. For example, paint identifying logic 124 receives sensor signals that indicate the type and/or amount of paint. In one instance, paint identifying logic 124 receives sensor signals from a camera and identifies the paint by the image (e.g., by reading a machine-readable code in the image such as a barcode, using optical character recognition to read a part number, etc.). In another instance, paint identifying logic 124 receives sensor signals from a wireless communications sensor and identifies paint source 127 based on the wireless signal (e.g., a RFID signal, a Bluetooth signal, an NFC signal, etc.). In other examples, paint identifying logic 124 can identify paint source 127 in other ways as well.

Paint flow logic 125 calculates or monitors paint flow through pump 138. For instance, paint flow logic 125 can receive sensor signals indicative of displacement of a piston within pump 138 and frequency of the piston reciprocation to calculate paint flow. In another example, paint flow logic 125 receives a signal from a paint flow meter. Paint flow logic 125 can calculate or monitor paint flow in other ways as well.

Paint coverage logic 126 calculates an area and thickness of paint coverage on a surface being covered by a spraying operation. For example, paint coverage logic 126 receives sensor signals from motion/location sensors (e.g., inertial measurement unit, gyroscope, accelerometer, proximity sensor, etc.) on an applicator and, a paint flow rate and a spray pattern area to calculate paint coverage. For instance, if applicator 108 moves slower during application the coverage area will be less but the coverage thickness will be greater. Paint coverage logic 126 can calculate an area and thickness of paint coverage in other ways as well. Paint coverage logic 610, in one example, can use visual aids to spatially map the covered paint area, including the ability to calculate the area of curved surfaces. Paint coverage logic 126, in one example, can use edge detection algorithms, smoothing algorithms, and determines where paint has or has not been applied, through color detection/light emission schemes.

Tip wear detection logic 128 calculates the wear of spray tip 176 during a spraying operation. For example, tip wear detection logic 128 can receive information from tip identifying logic 123 as to the characteristics of the spray tip 176 (e.g., the tip material, tip diameter tip orifice diameter, tip internal tip geometry, tip pressure ranges, etc.). Tip wear detection logic 128 can compare the standard characteristics of tip 176 (e.g., the characteristics the tip should have at manufacture) with the current detected characteristics of the tip to calculate a “tip life”. For example, one relevant tip characteristic related to the tip life is the tip orifice size which can be calculated based on the flow rate, pressure, pump characteristics, etc. Comparing the tip at manufacture orifice size to the current tip orifice size and the largest acceptable orifice size can indicate a life of the tip, that is, the length of time a tip has to work effectively. In other examples, tip wear logic 614 calculates tip wear based on the amount of paint flow that has been through tip 176 and/or the time that tip 176 has been used.

Control system 102 couples to a communication component 185 that allows communication with another device, such as a smart phone or other mobile device. For example, an interface can be on a mobile device (such as a mobile device) that sends control signals to control system 102 wirelessly, or through wired connection.

User interface logic 132 is configured to receive inputs and/or generate outputs using mechanisms 114. For instance, inputs can be received from a user 186 through a user device 188. In one example, user device 188 can include a remote device, such as a portable hand-held computing device (e.g., a cell phone). In another example, user device 188 can include a display device and/or user input controls onboard of spraying system 100.

Spray applicator control configuration input 190 is received from user device 188 and/or a configuration system 192, for use by configuration logic 122 in configuring control logic 121. In one example, configuration system 192 can be utilized during a manufacturing and/or pre-operation setup process of robotic spraying system 100.

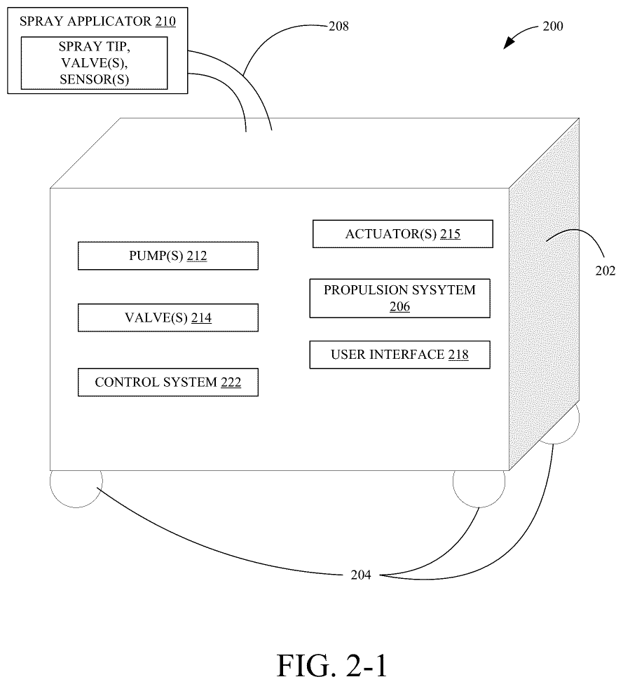

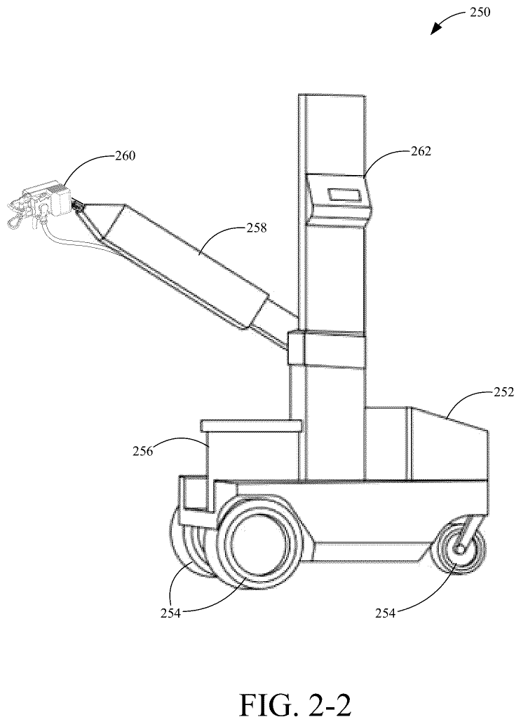

FIG. 2-1 is a diagrammatic view of one example of a robotic spraying system 200. System 200 illustratively includes a ground robot. System 200 includes a cart 202 configured to house various components of system 200. System 200 includes one or more ground engaging elements 204, such as wheels or tracks, coupled to cart 202. Ground engaging elements 204 are driven by a propulsion system to provide movement of spraying system 200. Additionally, cart 202 includes an arm 208 configured to support spray applicator 210. Robotic arm 208 is movable to any of a variety of different lengths to support spray applicator 210, which includes a spray tip, valves, sensors, etc. Examples of sensors include, but are not limited to, sensors 106 discussed above.

Spraying system 200 includes pumps 212 and valves 214. System 200 also includes actuator 215 configured to drive one or more of propulsion system 206, robotic arm 208, and pump 212. Control system 222 is configured to control the components of system 200. One example of control system 222 includes control system 102 discussed above with respect to FIG. 1. Also, system 200 can include a user interface 218 that allows an operator to initiate and/or modify the operation of system 200.

FIG. 2-2 is a perspective view of one example of a robotic spraying system 250. System 250 includes a base unit 252 having a propulsion system that includes a set of wheels 254, at least some of which are driven by an electric motor powered by a battery (not shown in FIG. 2-2) within base unit 252. System 250 includes a source of paint 256, illustratively a five-gallon bucket, and a control arm 258 moveably supported relative to base unit 252. A spray applicator 260 having a spray tip is carried on an end of arm 258. Spray applicator 260 is moveable, for example using a gimble, relative to arm 258 to orient the spray pattern for a surface to be sprayed. A controller 262 includes one or more processors configured to execute instructions and control system 250. Controller 260 can also include user input and/or user output mechanisms that allow a user to initiate a control operation of system 250.

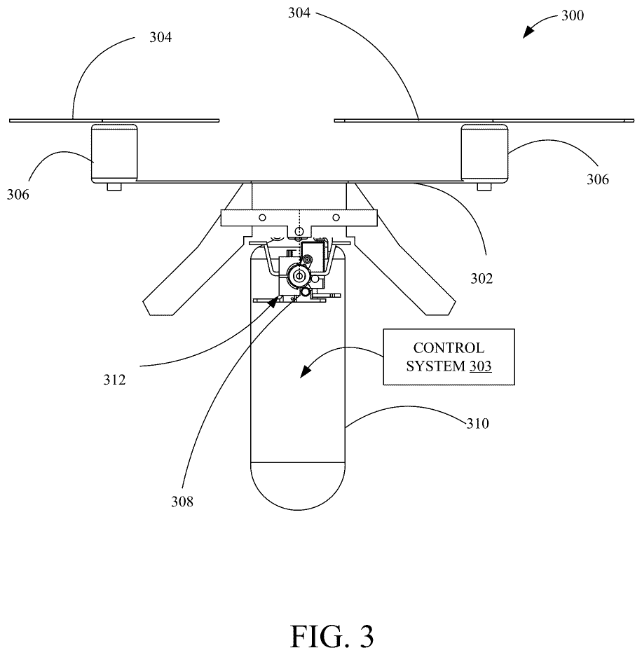

FIG. 3 is a diagrammatic view of one example of a robotic spraying system 300. As shown, system 300 comprises, in one example, an unmanned aerial vehicle (UAV) or aerial drone. System 300 includes one or more controllers 303. System 300 further includes a body 302 that couples to rotors 304 via actuators, such as motors 306. Each rotor spins as varying speeds and directions as is known to counter rotation forces exerted by the other spinning rotors. System 300 also includes fluid applicator assembly 308 that applies a fluid (e.g., paint) to a target surface (e.g., a wall). The fluid applied by fluid applicator assembly 308 is stored adjacent to a fluid reservoir 310 that is coupled to body 302.

As illustrated in FIG. 3, system 300 further includes one or more sensors 312. Sensors 312 may be placed adjacent to fluid applicator assembly 308 or may be placed at a different location on body 302 suitable for obtaining sensor data. In one embodiment, sensor 312 is an IR sensor. However, in other embodiments, a UV or thermal sensor may be utilized as well. In operation, sensors 312 detect spray characteristics of the fluid sprayed by fluid applicator assembly 308. Spray characteristics may include, for example, data relating to spray edges (e.g., locations of spray edges), in which sensors 312 detect a difference in temperature between the applied liquid and the surface to which the liquid is applied, the temperature difference being indicative of spray edges (e.g., locations of spray edges). Additionally, other characteristics may be detected as well, such as spray angle, spray density (e.g., spray thickness), etc. The spray characteristics data detected by sensors 312 are responsively obtained by control system 303 (which may comprise one or more processors) to identify spray characteristics of the spray site based on the received sensor data. One example of control system 303 includes control system 1602 discussed above with respect to FIG. 1.

Upon identification of the characteristics of interest, control system 303 may generate control signal(s) to control operation of system 300. For example, the control signal(s) may include an indication to change location, in which control system 303 cause motors 306 to rotate rotors 304 in varying directions to modify the position of system 300. The change in position may include, for example, a change in height, distance from the surface of interest, etc. In another example, the control signal(s) may control motors 306 to rotate rotors 304 in varying ways to control the position and movement of system 300 in a subsequent pass to desirably overlap a previous pass.

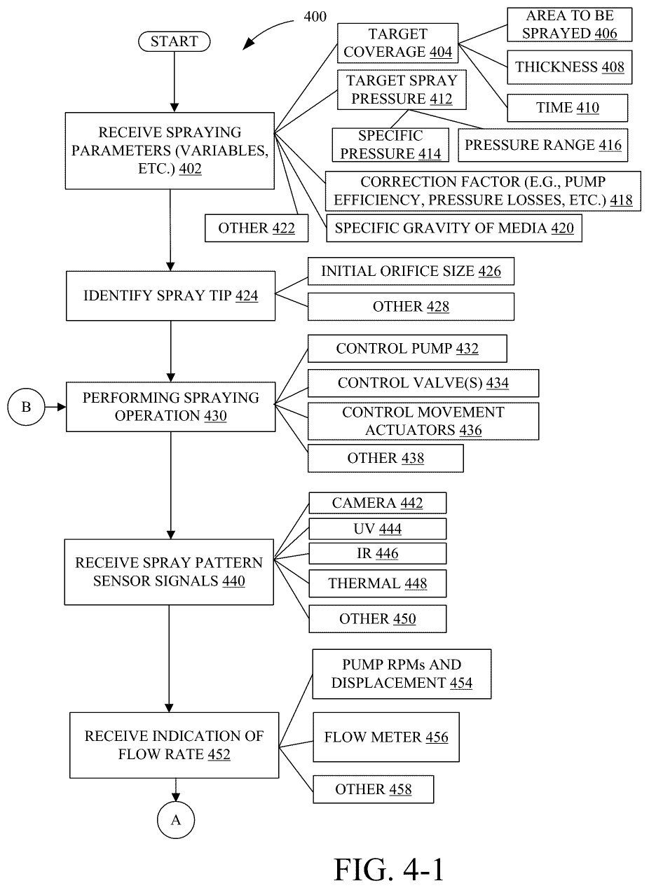

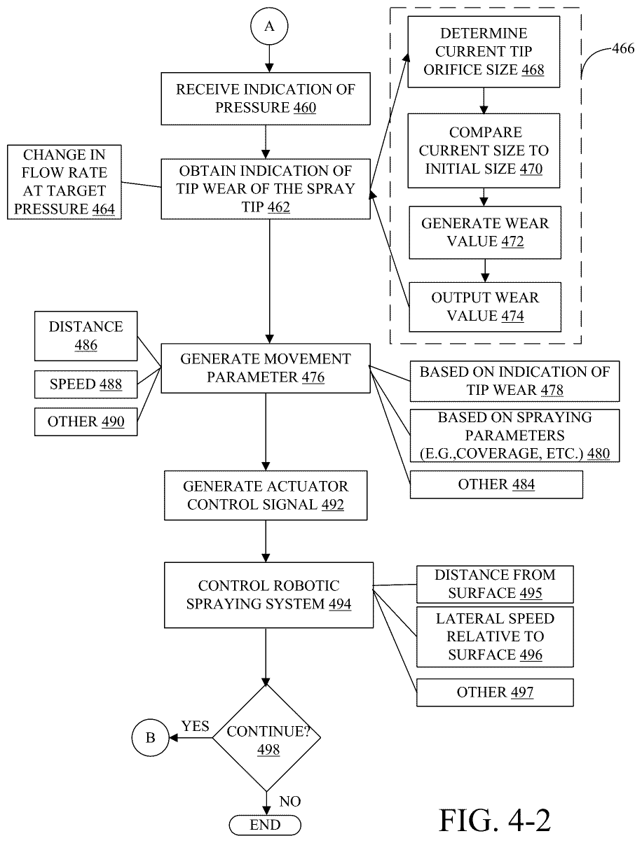

FIGS. 4-1 and 4-2 (collectively referred to as FIG. 4) illustrate one example operation of a robotic spraying system. For sake of illustration, but not by limitation, FIG. 4 will be discussed in the context of system 100 shown in FIG. 1.

At block 402, one or more spraying parameters are received, which can include, for example, target spraying application data 182. The one or more spraying parameters can include, but is not limited to, a target coverage 404 which can include a target area 406 to be sprayed, a target thickness 408, a time 407 within which the spraying operation is to be completed, and can include other coverage parameters as well. The target area 406 can include the dimensions of a wall or other surface to be covered, as well as coordinates of the boundary of that area. Also, the target thickness 408 can include a desired coverage in terms of mils (thousandths of an inch).

The one or more spraying parameters can also include a target spray pressure 412 at which the spraying operation is to be performed. The target spray pressure 412 can be selected to achieve a desired atomization. The target spray pressure 412 can be a specific pressure 414 (e.g., fifteen hundred pounds per square inch (PSI)) and/or a pressure range 416 (e.g., between fifteen hundred PSI and sixteen hundred PSI).

The spraying parameters can also include parameters associated with operation of the robotic spraying system. For example, a correction factor 418 represents a pump efficiency, pressure losses in the paint path, and/or other factors that represents a relationship between a pump control input and the paint pressure at the orifice. Alternatively, or in addition, a specific gravity 420 of the paint being sprayed is determined. Of course, other spraying parameters 422 can be received as well.

The spraying parameters at block 402 can be automatically determined and/or defined based on user input.

At block 424, spray tip 176 is identified by the system. Spray tip identification can be done in any of a number of ways. In one example, an operator inputs the characteristics of the spray tip, such as the orifice size. Alternatively, or in addition, the spray tip can be automatically identified at block 424, such as by scanning a code and/or wirelessly communicating with the spray tip upon insertion of the tip into the spray applicator. Examples of automatic spray tip detection are discussed above. In either case, an initial orifice size can be identified at block 426. Of course, the spray tip can be identified in other ways as well, as represented at block 428.

At block 430, the spraying operation is performed by control system 102 autonomously controlling spraying system 100 to achieve the target spraying application. The control can include, but is not limited to, controlling pump 138 at block 432, controlling valves 142 and/or 178 at block 434, controlling propulsion system 144 (e.g., movement actuators 150) at block 436, and can include other control as well, as represented at block 438.

At block 440, spray pattern sensor signals are received from spray pattern sensors 156. For example, sensor signals can be received from a camera (block 442), and ultraviolet (UV) sensor (block 444) and infrared (IR) sensor (block 446), a thermal sensor (block 448), or form other sensors (block 450).

The spray pattern sensor signals indicate whether the actual spraying operation is achieving the target spraying parameters, that is whether the target coverage is being achieved, or whether overspray, under spray, etc., is occurring.

At block 452, an indication of flow rate through the spray tip is received. One example includes receiving sensor signals indicative of pump speed (e.g., in terms of cycles or revolutions per minute), and the displacement of the pump with each cycle, as is represented at block 454. In one example, the pump speed is determined based on an indication of motor speed of the motor that drives the pump and a predefined relationship between the motor speed and the pump speed (e.g., a gear reduction, etc.). Alternatively, or in addition, a sensor can be received from a flow meter, as represented at block 456. Of course, the indication of flow rate can be received in other ways as well, as represented at block 458.

At block 460, an indication of the paint pressure is received. The indication can include, for example, a signal from pressure sensor 158.

At block 462, an indication of tip wear of spray tip 176 is obtained. In one example, the indication includes an indication of a change in flow rate (block 464) from spray tip 176 while spraying at the target pressure. For instance, as spray tip 176 wears during use, the flow rate at a given pressure tends to increase. Block 464 can identify the change in flow rate as a percentage increase (e.g., a ten percent increase in flow rate at a pressure of fifteen hundred PSI).

Alternatively, or in addition, block 462 can compute a wear status, as represented at reference numeral 466, which can indicate a remaining tip life. One example includes determining the current tip orifice size at block 468. The current tip orifice size can be determined, as discussed below. At block 470, the current tip size is compared to the initial tip size identified at block 426. Based on the comparison, a wear value or metric is generated at block 472. At block 474, an indication of the wear value is output. For example, a tip life indicator is output to a user to determine whether spray tip 176 should be replaced. In another example, a procedure is automatically initiated to facilitate replacement of spray tip 176.

At block 476, a movement parameter is generated based on one or more of the indication of tip wear (e.g., the change in flow rate) as represented at block 478, the spraying parameters at block 480, and/or other items 482. The movement parameter can represent any of a variety of different aspects to control movement of the spray tip relative to the surface. For example, the movement parameter can indicate a change in distance (block 486) for the spray tip from the surface. Alternatively, or in addition, the movement parameter can indicate a change to the lateral speed (block 488) that the spray tip should be moved relative to the surface while a particular distance is maintained between spray tip 176 and the surface. In one example, the change to the lateral speed is proportional to the increase in flow rate. For instance, if the flow rate increases by ten percent, the lateral speed is also increased by ten percent to compensate for tip wear (e.g., to maintain a target coating thickness while spraying at the target pressure).

Of course, other movement parameters can be utilized as well, as represented at block 490.

In one example, a target distance and/or a target speed of the spray tip relative to the surface is calculated given the current flow rate of the paint and the spray pattern sensed by sensors 156. The target distance and/or the target speed are calculated to achieve the target thickness.

At block 492, an actuator control signal is generated based on the movement parameter. The robotic spraying system is controlled at block 494 based on the actuator control system. For example, this can include automatically changing the distance of the spray tip from the surface, as represented at block 495, automatically changing the speed of the spray tip relative to the surface (as represented at block 496), or other types of automated control as represented at block 497. At block 498, the operation returns to block 430 is the spraying operation is continued.

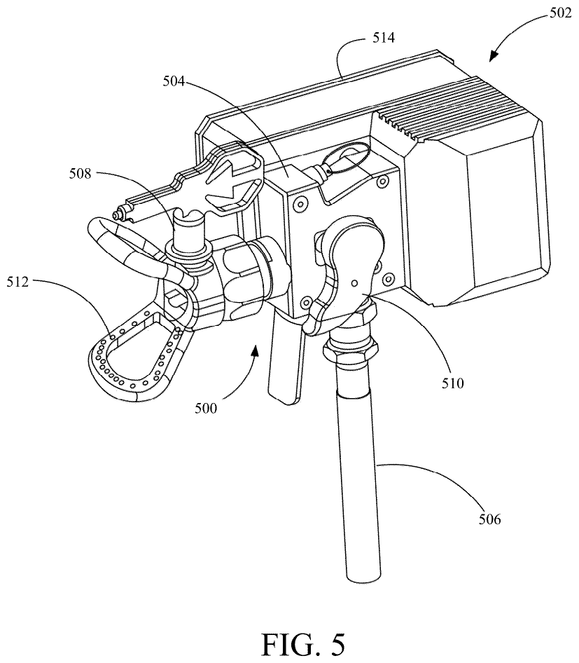

FIG. 5 illustrates a spray head 500 coupled to a robotic control assembly 502, in one example. Spray head 500 illustratively includes body 504 coupled to fluid line 506. Fluid line 506 is configured to allow fluid flow through body 504 and out of spray tip 508. Spray head 500 also includes tip housing 512 configured to couple spray tip 508 to body 504. Spray head further includes trigger 510, which extends upward along body 504 in order to allow for manual actuation of trigger 510 when coupled to robotic control assembly 502.

Robotic control assembly 502 includes a spray head coupler configured to receive and removably couple body 504 of spray head 500 to assembly 502, in order to robotically control the valve of spray head 500. Illustratively, robotic control assembly 502 includes housing 514 having a motor (such as a servo motor) disposed therein configured to drive actuation of the valve within spray head 500.

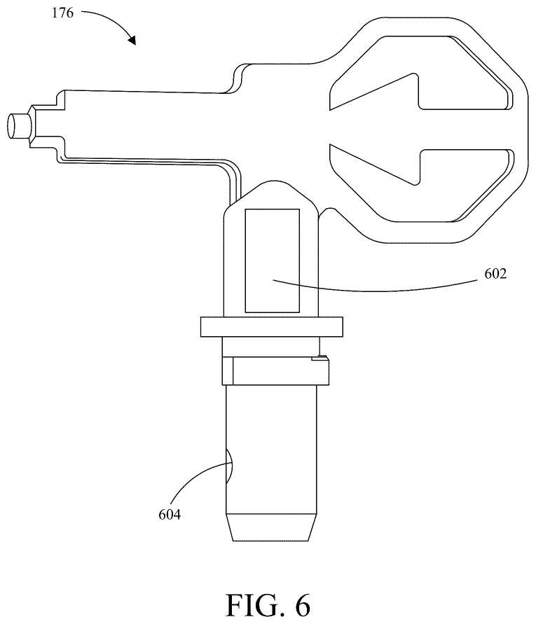

FIG. 6 is a side view showing spray tip 176, in one example. Spray tip 176, as shown, includes an identifier 602 that is an RFID tag. In this case, identifier 602 interacts with a tip sensor on spray applicator 108 that is an RFID reader. Spray tip 176 also has an outlet 604 where paint is expelled from. Each different kind of spray tip 176 can have a different outlet 604 (and/or internal geometry) that has characteristics that affect the fluid spray expelled from outlet 604. Because each spray tip 176 may have different spray characteristics, it is important to know which spray tip 176 is being used to better control the fluid spray from applicator 108.

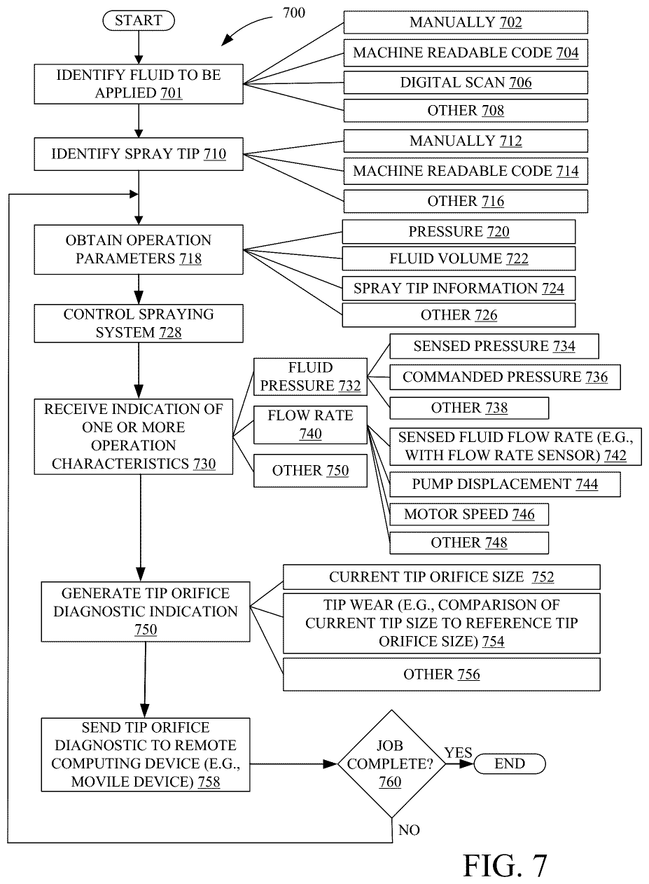

FIG. 7 is a flow diagram 700 showing an example operation of a spraying system. The spraying system can be, for example, spraying system 100 described above with respect to FIG. 1. The operation begins at block 701, where the fluid to be applied (e.g., fluid type, fluid volume to be applied, etc.) in a spraying operation is identified. The fluid can be identified by, for example, utilizing paint identifying logic 124 described above with respect to FIG. 1. As indicated by block 702, the fluid can be manually identified. As indicated by block 704, fluid can also be identified by scanning a machine-readable code (e.g., a bar or QR code). As indicated by block 706, fluid can also be identified by a digital scan. A digital scan can include, for example, taking a photo of the fluid and/or fluid container and comparing it to a fluid database within a data store. Additionally, the fluid to be applied can be identified in other ways as well, as indicated by block 708.

The operation proceeds as block 710, where the spray tip is identified (e.g., tip 176 is identified by tip identifying logic 123). Tip 176 can be identified in a variety of different ways, as indicated by blocks 712-716. As indicated by block 712, the tip can be identified manually. For example, a user can select the tip from a list of tips on an interface. The spray tip can also be identified by scanning a machine-readable code (e.g., a bar or QR code), as indicated by block 714. The tip can also be identified in other ways as well, as indicated by block 716. For example, an image of the tip can be taken and analyzed by tip identifying logic 123 to identify the tip.

At block 718, operation parameters are obtained. The operation parameters are indicative of the operational conditions for the particular spraying operation. For example, as indicated by block 720, the operation parameters include a pressure set point for operation of pump 138. The pressure set point can include a pressure recommendation provided to an operator for approval or acceptance. The pressure set point can be based on the identified fluid and/or identified top, and can be retrieved from a lookup table or database of fluids and tips, as. The pressure can also be identified using a stored algorithm, for example based on a tip orifice diagnostic calculation.

At block 722, the operation parameters can also include an indication of the volume of fluid (e.g., a desired flow rate) to be sprayed during the spraying operation. As indicated by block 724, the operation parameters can also include spray tip information. The spray tip information can be, for example, an indication of the type of spray tip (e.g., which indicates tip orifice size) being used for the operation. In another example, the spray tip information can be an indication that a spray tip has been connected such that the spraying system can proceed with operation. Additionally, it is expressly contemplated that other operation parameters can be received as well, as indicated by block 726.

Operation proceeds to block 728 where the spraying system is controlled or otherwise operated based on the operation parameters. Controlling the spraying system can include, for example, operating the motor at a selected motor speed to drive the pump to pump a fluid along a fluid path to the spray tip based on the pressure set point and/or desired flow rate.

Operation proceeds to block 730 where one or more characteristics of the operation are detected or otherwise identified. As indicated by block 732, detecting a characteristic of the fluid can include, for example, detecting a pressure of the fluid pumped along the fluid path to the spray tip. The fluid pressure can be, for example, a sensed pressure obtained from a pressure sensor that senses the fluid pressure as it travels along the fluid path to the spray tip, as indicated by block 734. In another example, the fluid pressure can be determined based on the commanded pressure, as indicated by block 736. Additionally, it is expressly contemplated that the fluid pressure can be detected in other ways as well, as indicated by block 738.

As indicated by block 740, obtaining a characteristic of the fluid can also include determining a flow rate of the fluid. The flow rate can be, for example, a sensed fluid flow rate that is sensed as fluid travels along the fluid path to the spray tip (e.g., with a fluid flow rate sensor), as indicated by block 742. In another example, the flow rate can be detected based on an indication of an output of the pump of the spraying system. The indication of the output can be, for instance, based on pump displacement, as indicated by block 744. For instance, pump cycles can be monitored to determine the rate at which fluid is pumped through the fluid path and output from the spray tip. Alternatively, or in addition, the flow rate can be determined based on a detected motor speed of the spraying system motor, as indicated by block 746.

In one example, the flow rate can be calculated by utilizing the conventional Bernoulli equation, reproduced below in equation 1.

P₁+½ρv₁²+μgh₁=P₂+½ρv₂²+ρgh₂ Eq. 1

Where ρ refers to fluid density, g refers to acceleration due to gravity, P₁ refers to the pressure at a first elevation, v₁ refers to the velocity at the first elevation, h₁ refers to the height at the first elevation, P₂ refers to the pressure at the second elevation, v₂ refers to the velocity at the second elevation, and h₂ refers to the height at the second elevation.

It is expressly contemplated that flow rate can be determined in other ways as well, as indicated by block 748.

Operation proceeds to block 750 where a tip orifice diagnostic indication is generated. Generating the tip orifice diagnostic can include determining the current tip orifice size, as indicated by block 752. For example, the current tip size can be determined based on the fluid pressure and the flow rate. In one example, the tip orifice size can be calculated using an orifice flow equation.

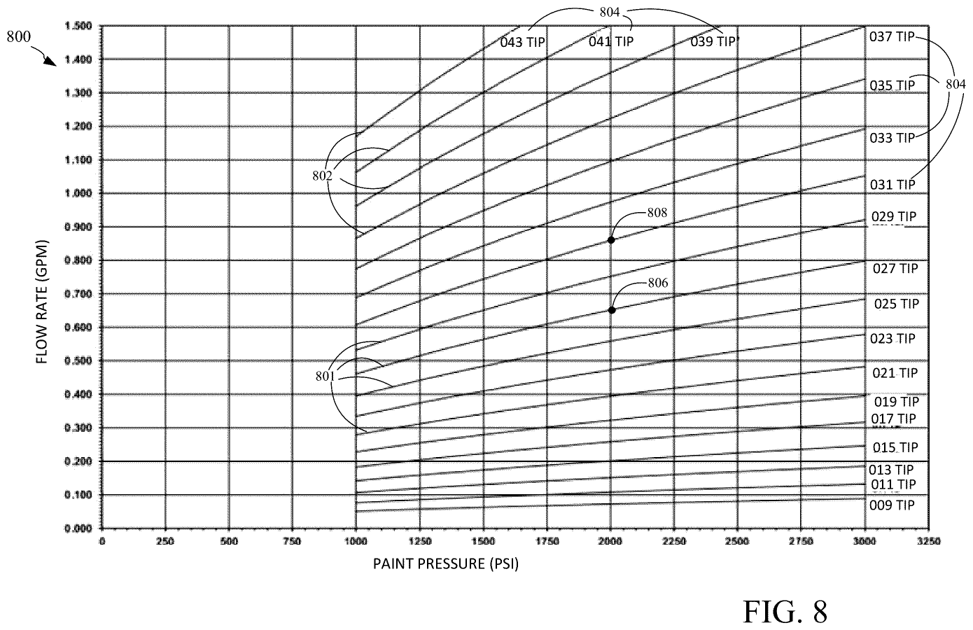

FIG. 8 provides a chart 800 having a plurality of curves 802 illustrating example spray tip orifice calculations based on pressure and flow rate. Each curve 802 represents a given spray tip orifice size, in a plurality of different spray tip orifice sizes 804, and graphs a relationship between paint spray pressure and flow rate for the given spray tip orifice size. The calculations in chart 800 can be used, for example, at blocks 1267 and/or 1954. For a given sensed pressure and flow rate, a spray tip orifice calculation determines the size (e.g., in terms of cross-sectional area, diameter, width, etc.), of the spray tip orifice. For sake of illustration, but not by limitation, assume a pressure of two thousand PSI detected. If a flow rate of 0.65 gallon per minute (GPM) is detected, the system determines that the spray tip has an orifice size of 0.027 millimeters, as represented by point 806 in FIG. 8. If the flow rate increases to 0.85 GPM for the same pressure, then the system determines that the spray tip has worn to an orifice size of 0.031 millimeters, as represented by point 808.

Referring again to FIG. 7, generating the tip orifice diagnostic indication can include generating a tip wear indication, as indicated by block 754. The tip wear indication can be generated by, for example, comparing a current tip orifice size to a reference tip orifice size, and providing the indication of the tip orifice diagnostic based on the comparison. The reference tip orifice size can be, for example, an operation standard or metric in which the tip orifice is expected to be at manufacture. Additionally, it is expressly contemplated that a different tip orifice diagnostic indication can be generated as well, as indicated by block 756.

Operation proceeds to block 758 where the tip orifice diagnostic can be sent to a remote computing device. The remote computing device can be, for example, a mobile device configured to display the tip orifice diagnostic indication on a display.

Operation proceeds to block 760, where it is determined if the job is complete. If so, then operation ends. If not, then operation proceeds at block 718.

It should also be noted that the different examples described herein can be combined in different ways. That is, parts of one or more examples can be combined with parts of one or more other examples. All of this is contemplated herein.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

As used herein, if a description includes “one or more of” or “at least one of” followed by a list of example features with a conjunction “or” between the penultimate example feature and the last example feature, then this is to be read such that (1) one exemplary embodiment includes at least one of or one or more of each feature of the listed features, (2) another exemplary embodiment includes at least one of or one or more of only one feature of the listed features, and (3) another exemplary embodiment includes some combination of the listed features that is less than all of the features and more than one of the features.

As used herein, if a description includes “one or more of” or “at least one of” followed by a list of example features with a conjunction “and” between the penultimate example feature and the last example feature, then this is to be read such that the exemplary embodiment includes at least one of or one or more of each feature of all the listed features.

As used herein, if a description includes “one or more of” or “at least one of” followed by a list of example features with a conjunction “and/or” between the penultimate example feature and the least example feature, then this is to be read such that, in one example, the description includes “one or more of” or “at least one of” followed by a list of example features with a conjunction “or” between the penultimate example feature and the last example feature, and, in another example, the description includes “one or more of” or “at least one of” followed by a list of example features with a conjunction “and” between the penultimate example feature and the last example feature.

The present discussion has mentioned processors and/or servers. In one embodiment, the processors and/or servers include computer processors with associated memory and timing circuitry, not separately shown. They are functional parts of the systems or devices to which they belong and are activated by and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

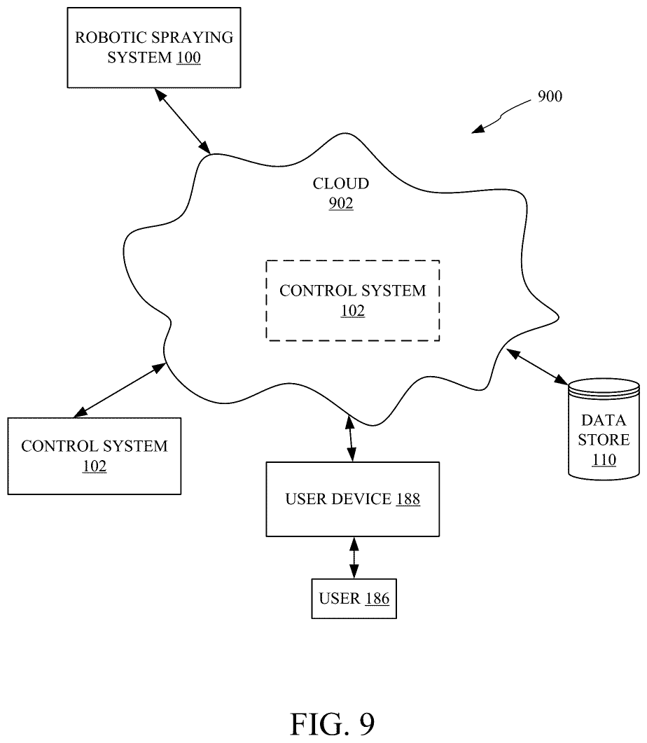

FIG. 9 is a block diagram of robotic spraying system 100, shown in FIG. 1, deployed in a remote server architecture 900. In an example, remote server architecture 900 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in FIG. 1 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 9, some items are similar to those shown in FIG. 1 and they are similarly numbered. FIG. 9 specifically shows that control system 102 can be located at a remote server location 902. Alternatively, or in addition, data store 110 can be located at the remote server location 902. Therefore, user device 188, user 186, robotic spraying system 100, and other components access those systems through remote server location 902.

FIG. 9 also depicts another example of a remote server architecture. FIG. 9 shows that it is also contemplated that some elements of FIG. 1 are disposed at remote server location 902 while others are not. By way of example, control system 102 can be disposed at a location separate from remote server location 902 and accessed through the remote server location 902. Further, data store 110 can be disposed at a location separate from remote server location 902 and accessed through the remote server location 902. Regardless of where they are located, they can be accessed directly by robotic spraying system 100, through a network (either a wide area network or a local area network), they can be hosted at a remote site by a service, or they can be provided as a service, or accessed by a connection service that resides in a remote location.

It will also be noted that the elements of FIG. 1, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

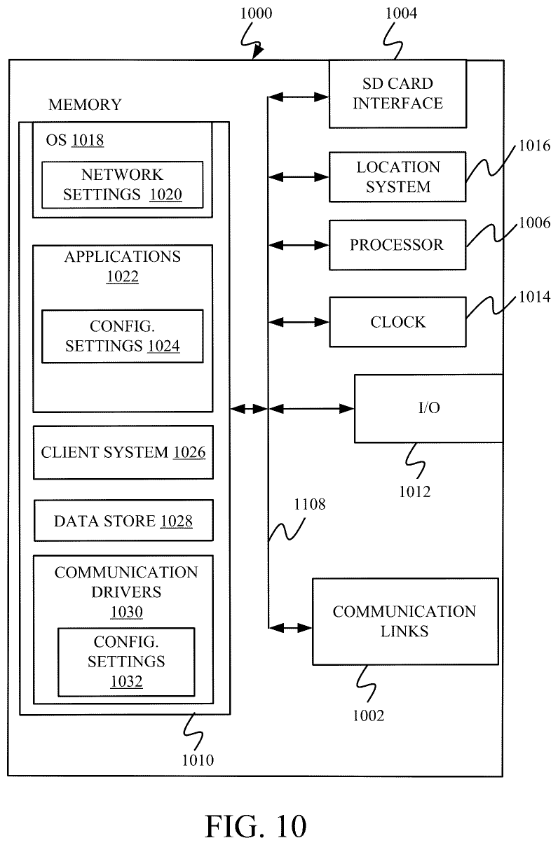

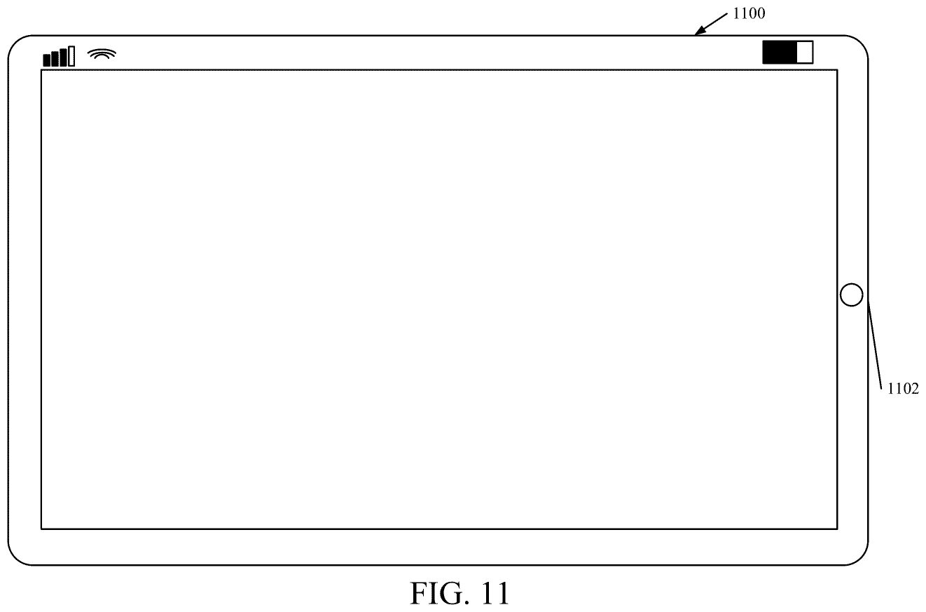

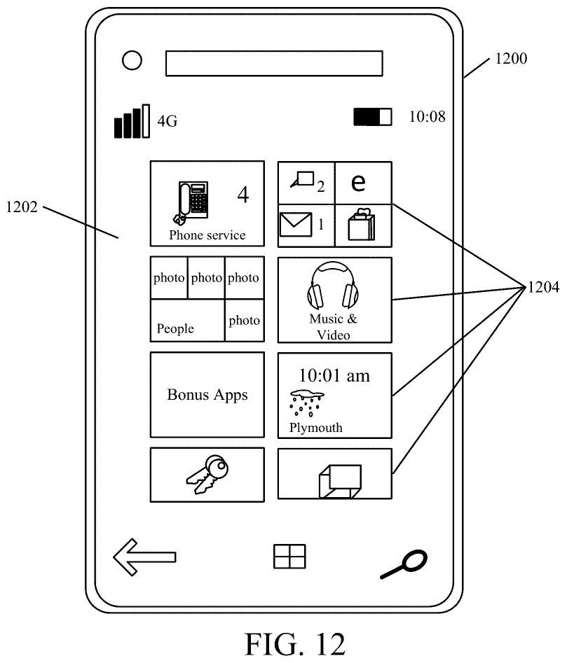

FIG. 10 is a simplified block diagram of one illustrative example of a handheld or mobile computing device that can be used as a user's or client's device 1000, in which the present system (or parts of it) can be deployed. FIGS. 11-12 are examples of handheld or mobile devices.

FIG. 10 provides a general block diagram of the components of a device 1000 that can run some components shown in FIG. 1, that interacts with them, or both. In device 1000, a communications link 1002 is provided that allows the handheld device to communicate with other computing devices and under some embodiments provides a channel for receiving information automatically, such as by scanning. Examples of communications link 1002 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1004. Interface 1004 and communications link 1002 communicate with a processor 1006 (which can also embody processors or servers from previous FIGS.) along a bus 1008 that is also connected to memory 1010 and input/output (I/O) components 1012, as well as clock 1014 and location system 1016.

I/O components 1012, in one example, are provided to facilitate input and output operations. I/O components 1012 for various embodiments of the device 1000 can include input components such as buttons, touch sensors, optical sensors, microphones, touch screens, proximity sensors, accelerometers, orientation sensors and output components such as a display device, a speaker, and or a printer port. Other types of I/O components 1012 can be used as well.

Clock 1014 illustratively comprises a real time clock component that outputs a time and date. It can also, illustratively, provide timing functions for processor 1006.

Location system 1016 illustratively includes a component that outputs a current geographical location of device 1000. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1010 stores operating system 1018, network settings 1020, applications 1022, application configuration settings 1024, a client system 1026, data store 1028, communication drivers 1030, and communication configuration settings 1032. Memory 1010 can include all types of tangible volatile and non-volatile computer-readable memory devices. It can also include computer storage media (described below). Memory 1010 stores computer readable instructions that, when executed by processor 1006, cause the processor to perform computer-implemented steps or functions according to the instructions. Processor 1006 can be activated by other components to facilitate their functionality as well.

FIG. 11 shows one example in which device 1000 is a tablet computer 1100. In FIG. 11, computer 1100 is shown with user interface display screen 1102. Screen 1102 can be a touch screen or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 1100 can also illustratively receive voice inputs as well.

FIG. 12 shows that the device can be a smart phone 1200. Smart phone 1200 has a touch sensitive display 1202 that displays icons or tiles or other user input mechanisms 1204. Mechanisms 1204 can be used by a user to run applications, make calls, perform data transfer operations, etc. In general, smart phone 1200 is built on a mobile operating system and offers more advanced computing capability and connectivity than a feature phone. Note that other forms of device 1000 are possible.

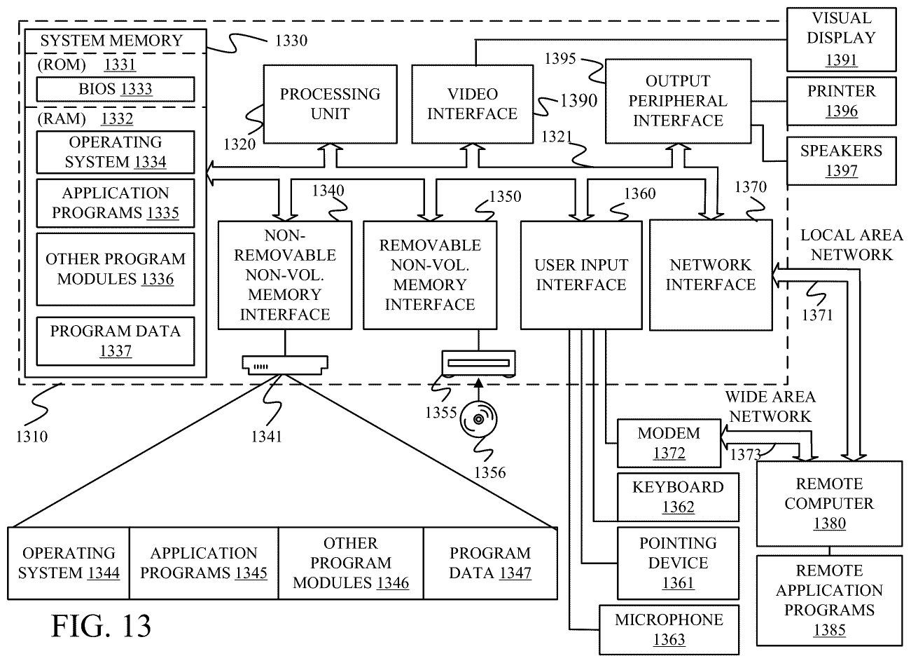

FIG. 13 is one example of a computing environment in which elements of FIG. 1, or parts of it, (for example) can be deployed. With reference to FIG. 13, an example system for implementing some embodiments includes a computing device in the form of a computer 1310. Components of computer 1310 may include, but are not limited to, a processing unit 1320 (which can comprise processors or servers from previous FIGS.), a system memory 1330, and a system bus 1321 that couples various system components including the system memory to the processing unit 1320. The system bus 1321 may be any of several types of bus structures including a memory bus or memory controller, a peripheral bus, and a local bus using any of a variety of bus architectures. Memory and programs described with respect to FIG. 1 can be deployed in corresponding portions of FIG. 13.

Computer 1310 typically includes a variety of computer readable media. Computer readable media can be any available media that can be accessed by computer 1310 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1310. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1330 includes computer storage media in the form of volatile and/or nonvolatile memory such as read only memory (ROM) 1331 and random-access memory (RAM) 1332. A basic input/output system 1333 (BIOS), containing the basic routines that help to transfer information between elements within computer 1310, such as during start-up, is typically stored in ROM 1331. RAM 1332 typically contains data and/or program modules that are immediately accessible to and/or presently being operated on by processing unit 1320. By way of example, and not limitation, FIG. 13 illustrates operating system 1334, application programs 1335, other program modules 1336, and program data 1337.

The computer 1310 may also include other removable/non-removable volatile/nonvolatile computer storage media. By way of example only, FIG. 13 illustrates a hard disk drive 1341 that reads from or writes to non-removable, nonvolatile magnetic media, an optical disk drive 1355, and nonvolatile optical disk 1356. The hard disk drive 1341 is typically connected to the system bus 1321 through a non-removable memory interface such as interface 1340, and optical disk drive 1355 is typically connected to the system bus 1321 by a removable memory interface, such as interface 1350.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 1310. In FIG. 13, for example, hard disk drive 1341 is illustrated as storing operating system 1344, application programs 1345, other program modules 1346, and program data 1347. Note that these components can either be the same as or different from operating system 1334, application programs 1335, other program modules 1336, and program data 1337.

A user may enter commands and information into the computer 1310 through input devices such as a keyboard 1362, a microphone 1363, and a pointing device 1361, such as a mouse, trackball or touch pad. Other input devices (not shown) may include a joystick, game pad, satellite dish, scanner, or the like. These and other input devices are often connected to the processing unit 1320 through a user input interface 1360 that is coupled to the system bus but may be connected by other interface and bus structures. A visual display 1391 or other type of display device is also connected to the system bus 1321 via an interface, such as a video interface 1390. In addition to the monitor, computers may also include other peripheral output devices such as speakers 1397 and printer 1396, which may be connected through an output peripheral interface 1395.

The computer 1310 is operated in a networked environment using logical connections (such as a local area network—LAN, or wide area network—WAN or a controller area network-CAN) to one or more remote computers, such as a remote computer 1380.

When used in a LAN networking environment, the computer 1310 is connected to the LAN 871 through a network interface or adapter 1370. When used in a WAN networking environment, the computer 1310 typically includes a modem 1372 or other means for establishing communications over the WAN 1373, such as the Internet. In a networked environment, program modules may be stored in a remote memory storage device. FIG. 13 illustrates, for example, that remote application programs 1385 can reside on remote computer 1380.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts mentioned above are disclosed as example forms of implementing the claims.

What is claimed is:

1. A robotic paint spraying system comprising:
a paint applicator including a spray tip having at least one tip orifice configured to spray a paint;
a propulsion system comprising one or more actuators configured to move the paint applicator relative to a surface to be sprayed; and
a control system configured to:
obtain one or more spraying parameters representing a target paint spraying operation corresponding to the surface;
generate a first actuator control signal that controls the propulsion system to move the spray tip at a speed relative to the surface;
control the robotic paint spraying system to spray paint from the spray tip to the surface at a target pressure;
obtain an indication of tip wear of the spray tip;
generate a movement parameter based on the indication of tip wear; and
generate a second actuator control signal that controls the propulsion system to move the spray tip relative to the surface based on the movement parameter.

2. The robotic paint spraying system of claim 1, wherein the indication of tip wear of the spray tip comprises an indication of a change in flow rate of the paint through the spray tip at the target pressure.

3. The robotic paint spraying system of claim 2, and further comprising a paint pump, wherein the indication of the change in flow rate of the paint comprises an indication of a change in a pump speed of the paint pump.

4. The robotic paint spraying system of claim 1, and further comprising:
a position sensor configured to generate a sensor signal indicating a relative position of the spray tip relative to the surface to be sprayed, wherein the control system is configured to:
generate the second actuator control signal based on the sensor signal and the movement parameter.

5. The robotic paint spraying system of claim 4, wherein the movement parameter represents at least one of:
a change in the relative position, or
a change in the speed.

6. The robotic paint spraying system of claim 1, wherein the robotic paint spraying system comprises a ground drone having at least one of:
one or more tracks, or
one or more wheels.

7. The robotic paint spraying system of claim 1, wherein the robotic paint spraying system comprises an unmanned aerial vehicle.

8. The robotic paint spraying system of claim 1, wherein the target pressure comprises at least one of:
a specific pressure, or
a pressure range.

9. The robotic paint spraying system of claim 1, wherein the control system is configured to:
identify a first tip orifice size of the tip orifice;
determine a current tip orifice size of the tip based on at least one of:
an indication of a flow rate of paint through the tip orifice, and
an indication of a pressure of the paint;
generate a comparison result based on a comparison of the current tip orifice size to the first tip orifice size; and
generate a wear status indicative of an amount of wear of the tip based on the comparison result.

10. The robotic paint spraying system of claim 1, wherein the control system is configured to:
obtain a target thickness of the paint on the surface; and
generate the first actuator control signal based on the target thickness.

11. The robotic paint spraying system of claim 10, wherein the control system is configured to compensate for the tip wear to maintain the target thickness of the paint.

12. The robotic paint spraying system of claim 1, and further comprising:
a spray pattern sensor configured to generate an indication of a spray pattern from the spray tip, wherein the control system is configured to generate the second actuator control signal based on the indication of the spray pattern.

13. The robotic paint spraying system of claim 12, wherein the indication of the spray pattern comprises an indication of a first area of the surface sprayed during a first pass, and the second actuator control signal is configured to control the robotic paint spraying system to spray a second area of the surface adjacent the first pass.

14. The robotic paint spraying system of claim 12, wherein the spray pattern sensor comprises at least one of:
a camera;
an infrared (IR) sensor;
an ultraviolet (UV) sensor; or
a thermal sensor.

15. A method of controlling a robotic paint sprayer, the method comprising:
obtaining one or more spraying parameters representing a target paint spraying operation to spray paint on a surface;
generating a first actuator control signal that controls the robotic paint sprayer to move a spray tip at a speed relative to the surface;
controlling the robotic paint sprayer to spray paint from the spray tip to the surface at a target pressure;
obtaining an indication of tip wear of the spray tip;
generating a movement parameter based on the indication of tip wear; and
generating a second actuator control signal that controls the robotic paint sprayer to move the spray tip relative to the surface based on the movement parameter.

16. The method of claim 15, and further comprising:
receiving a sensor signal indicating a relative position of the spray tip relative to the surface to be sprayed; and
generating the second actuator control signal based on the sensor signal and the movement parameter, wherein the movement parameter represents at least one of:
a change in the relative position, or
a change in the speed.

17. The method of claim 15, wherein the indication of tip wear of the spray tip comprises an indication of a change in flow rate of the paint through the spray tip at the target pressure.

18. The method of claim 17, wherein
the target pressure comprises at least one of:
a specific pressure, or
a pressure range; and
the indication of the change in flow rate of the paint comprises an indication of a change in a pump speed of a paint pump.

19. A control system for a robotic paint sprayer, the control system comprising:
at least one processor, and
memory storing instructions executable by the at least one processor, wherein the instructions, when executed, cause the control system to:
obtain one or more spraying parameters representing a target paint spraying operation to spray paint on a surface;
generate a first actuator control signal that controls the robotic paint sprayer to move a spray tip at a speed relative to the surface;
control the robotic paint sprayer to spray paint from the spray tip to the surface at a target pressure;
obtain an indication of a change in flow rate of the paint through the spray tip at the target pressure;
generate a movement parameter based on the indication of the change in flow rate; and
generate a second actuator control signal that controls the robotic paint sprayer to move the spray tip relative to the surface based on the movement parameter.

20. The control system of claim 19, wherein the instructions, when executed, cause the control system to:
receive a sensor signal indicating a relative position of the spray tip relative to the surface to be sprayed; and
generate the second actuator control signal based on the sensor signal and the movement parameter, wherein the movement parameter represents at least one of:
a change in the relative position, or
a change in the speed.
